(19) United States
(12) Patent Application Publication
(10) Pub. No.: US 2016/0350855 A1
(43) Pub. Date: Dec. 1, 2016

(54) Commodities Trading Platform

(71) Applicant: Julie A. Lerner, New York, NY (US)

(72) Inventor: Julie A. Lerner, New York, NY (US)

(21) Appl. No.: 15/170,915

(22) Filed: Jun. 1, 2016

Related U.S. Application Data
(60) Provisional application No. 62/169,133, filed on Jun. 1, 2015.

(51) Int. Cl. G06Q 40/04

(52) U.S. Cl. CPC G06Q 40/04

(57) ABSTRACT

Methods and systems described herein use metadata to define, detect, and execute arbitrage opportunities between a commodity at origin and one delivered to a destination (i.e., transportation spreads), and also between refining spreads. Systems and methods described herein lock in profits between an underlying cash market and a futures contract, a currency market, a freight market, a dark pool, other financial instruments or another commodity market. In some implementations, when a bid or offer is placed by a buyer or seller using the platform and a match is made, the system converts the bid or offer into a legally-binding contract, creating real-time arbitrage opportunities that do not currently exist.

### CROSS-REFERENCE TO RELATED APPLICATION

The present application claims priority to and benefit from U.S. Provisional Patent Application No. 62/169,133 titled “Physicals Commodity Trading Platform” filed on Jun. 1, 2015, the entire content of which is herein expressly incorporated by reference for all purposes.

### TECHNICAL FIELD

Various embodiments of the present disclosure generally relate to trading. More specifically, various embodiments of the present disclosure relate to a physicals commodity and/or a financial instruments trading platform.

### BACKGROUND

Price data in some markets, such as commodity markets, is collected and dispersed predominately through phone brokers or restricted trading windows. This practice leads to a lack of objective, accurate, and actionable information. Additionally, trading systems that use phone brokers are opaque and disaggregated, allowing for manipulation and misinterpretation and unnecessary risk exposure.

The present disclosure overcomes these and other limitations of existing trading systems, and provides other benefits, as will become clear to those skilled in the art from the following description.

### BRIEF DESCRIPTION OF THE DRAWINGS

Embodiments of the present disclosure will be described and explained through the use of the accompanying drawings in which:

FIG. 1 illustrates an example of a network-based operating environment in accordance with various embodiments of the present disclosure;

FIG. 2 illustrates a set of components in a Commodities Trading Platform according to one or more embodiments of the present disclosure;

FIG. 3 illustrates a user interface showing general market data in accordance with various embodiments of the present disclosure;

FIG. 4 is a diagram illustrating data derived from the Commodities Trading Platform in accordance with various embodiments of the present disclosure;

FIG. 5 illustrates a user interface showing market price analytics for a product by region in accordance with various embodiments of the present disclosure;

FIG. 6 illustrates a sample user interface showing the competitiveness of an entity in the marketplace in accordance with various embodiments of the present disclosure;

FIG. 7 illustrates a user interface showing data by approved and blocked counterparts in accordance with various embodiments of the present disclosure;

FIG. 8 is a diagram illustrating how cash markets trade in prior art systems;

FIG. 9 is a diagram illustrating how cash markets, such as dry bulk commodities, trade using the Commodities Trading Platform;

FIG. 10 is a diagram illustrating how cash markets, such as liquid commodities, trade using the Commodities Trading Platform;

FIG. 11 is a flow chart illustrating how spreads are executed in legacy systems;

FIG. 12 is a flow chart illustrating how spreads are executed using the Commodities Trading Platform;

FIG. 13 illustrates a user interface showing market price analytics for a product at origin in accordance with various embodiments of the present disclosure;

FIG. 14 illustrates a user interface showing market price analytics for a product at destination in accordance with various embodiments of the present disclosure;

FIG. 15 illustrates a user interface showing an example of a live trading screen with bids and offers in accordance with various embodiments of the present disclosure;

FIG. 16 illustrates a user interface showing an example of a bid sheet for a user to input a bid in accordance with various embodiments of the present disclosure;

FIG. 17 illustrates a user interface showing an example of a bid sheet for a user to input a bid in accordance with various embodiments of the present disclosure;

FIG. 18 illustrates a user interface showing an example of a bid sheet for a user to input a bid in accordance with various embodiments of the present disclosure;

FIG. 19 illustrates a user interface showing an example of a counter offer sheet in accordance with various embodiments of the present disclosure;

FIGS. 20A and 20B illustrate an example of a trader setting parameters for a trade using the Commodities Trading Platform in accordance with various embodiments of the present disclosure;

FIGS. 21A and 21B illustrate an example of a trader setting parameters for a trade using the Commodities Trading Platform in accordance with various embodiments of the present disclosure;

FIG. 22 is a flowchart illustrating an example of locking in arbitrage using the Commodities Trading Platform in accordance with various embodiments of the present disclosure;

FIG. 23 is a flowchart illustrating an example of how orders are simultaneously executed in accordance with various embodiments of the present disclosure; and

FIG. 24 illustrates an example of a computer system with which various embodiments of the present disclosure may be utilized.

### DETAILED DESCRIPTION

Various embodiments of the present disclosure generally relate to trading systems. More specifically, various embodiments of the present disclosure relate to systems and methods for deriving market data and for signaling and executing arbitrage opportunities.

In world markets and even regional commodity markets, there is no centrally-located source online or offline for viewing and analyzing supply, demand, and prices, including real-time price of spot and forward prices. To attempt to determine such information, one must speak with several brokers, view several emails and daily market reports, and examine price sheets from buyers and sellers. Even when a trader has gathered the relevant information, the trader cannot conclusively confirm that the bids and offers for the product remain valid. Because the trades are not executed in real time, the broker then needs to go back to the original bidder/offer to negotiate and/or accept. Thus, trades for physical commodities are a gentlemen's agreement at best.

Moreover, without a central location for live prices, there is no way to lock in any trade disparities such as a discounted transport or a spread between two instruments. Analyzing data is left to the individual, requiring the individual to accrue and interpret as best as possible using the unverified values. Without this system, traders exposed to risks that cannot be hedged.

Additional issues stem from collecting and dispersing trading data through phone brokers. For example, the price data in such systems is often subjective because the broker or the client has provided either misleading or no information or as it suits his or her agenda. Additionally, daily settlement prices submitted to the price reporting agencies (PRA) may also be subjective for the same reason. Lack of an objective PRA leaves world-market pricing to the opinions and methodologies of very few individuals, resulting in subjective, inaccurate pricing.

The Commodities Trading Platform provides performance metrics using metadata for a firm or an individual trader. Additionally, the Commodities Trading Platform uses metadata to define, detect, and execute arbitrage opportunities between a commodity at origin and one delivered to a destination (i.e., transportation spreads), and also between refining spreads. The Commodities Trading Platform locks in profits between an underlying cash market and a futures contract. When a bid or offer is placed by a buyer or seller using the platform and a match is made, the Commodities Trading Platform converts the bid or offer into a legally-binding contract, which creates real-time arbitrage opportunities that do not currently exist. This creates new profit opportunities in the best case scenario but, more importantly, protects traders from risks of completing only one side of the transaction. This is particularly important as electronic trading markets move in nanoseconds. In the age of high-frequency trading, it is often impossible to complete a multi-dimensional transaction and to do so without risk. Multi-dimensional transactions include, but are not limited to: one that ties different fungible markets such as a commodity and a transportation market, a commodity and a currency market, a financial instrument and a currency or interest rate market, a futures and a physicals market, between two commodity markets such as a raw product and a refined product, or any combination therein.

Benefits of the Commodities Trading Platform include an ability to derive instant, accurate and actionable market data. Additionally, the system provides the ability to signal and execute arbitrage opportunities through the system to electronically and instantly lock in profits from spread disparities. Spread disparities may include disparities between a futures contract and the underlying physical commodity, a transportation spread, a delivery spread between two financial instruments, or a quality or grade disparity between two financial instruments or physical commodities. Providing one venue for the trade of multiple markets in a supply chain (e.g., wheat and dry bulk freight, fuel oil and pipeline transport, world crude oil, currencies, futures, and physicals) offers an unprecedented opportunity to lock in profits and/or avoid losses, as well as monitor trading and risk management performance in a manner that is impossible offline.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer, mobile phone, or wearable technology (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

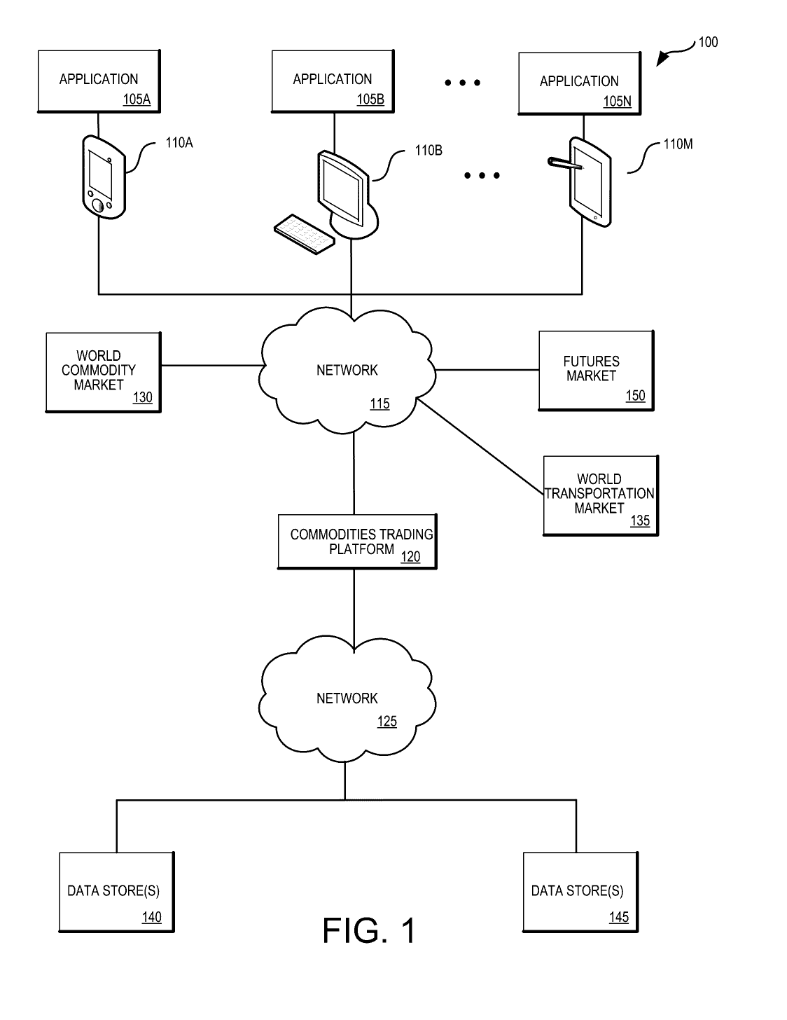

FIG. 1 illustrates an example of a network-based operating environment 100 in which some embodiments of the present disclosure may be used. As illustrated in FIG. 1, operating environment 100 includes applications 105A-105N running on one or more computing devices 110A-110M (such as a mobile device; a mobile phone; a tablet computer; a mobile media device; a mobile gaming device; a vehicle-based computer; a dedicated terminal; a public terminal, desktop, or laptop computer; a kiosk; or wearable technology). In some embodiments, applications 105A-105N can carry out operations, such as generating orders and checking account balances, and may be stored on the computing devices or remotely. These computing devices can include mechanisms for receiving and sending traffic by connecting through network 115 to Commodities Trading Platform 120.

Computing devices 110A-110M are configured to communicate via network 115 with Commodities Trading Platform 120. In some embodiments, computing devices 110A-110M can retrieve or submit information to Commodities Trading Platform 120 and run one or more applications with customized content retrieved by Commodities Trading Platform 120. For example, computing devices 110A-110M can each execute a browser application or a customized client to enable interaction between the computing devices 110A-110M and Commodities Trading Platform 120. In some embodiments, broker-dealers (i.e., entities including natural persons, companies, or other organizations engaged in the business of trading) access the Commodities Trading Platform 120 by operating computing devices 110A-110M. Broker-dealers may receive orders from customers or may create their own orders. In some embodiments, customers operate computing devices 110A-110M directly to communicate with Commodities Trading Platform 120.

Commodities Trading Platform 120 can run on one or more servers and can be used to provide a marketplace to trade commodities such as grains, softs (coffee, sugar, cotton, and cocoa), energy, metals and any byproduct of them such as gasoline, refined sugar, and wheat flour. Commodities Trading Platform 120 is communicably coupled with one or more world or regional commodity markets 130, world or regional transportation markets 135, world or regional futures market 150, and/or other world or regional financial markets and datastores 140 and 145 through network 125. World or regional commodity markets 130 may receive market information from global or regional producers, global or regional refiners, and global or regional tradehouses/warehouses. World transportation markets 135 may receive market information from the world transportation market. The world or regional transportation market 135 may include pipeline, electricity wires, boat, barge, truck, rail car, and airplane. World or regional futures market 150 may receive market information from various futures markets. Commodities Trading Platform 120 may consolidate and analyze market information from world commodity markets 130, world transportation markets 135, futures markets 150, and data stores 140 and 145 to determine arbitrage opportunities in the commodity and transportation markets.

Using the information from world commodity markets 130, world transportation markets 135, and futures markets 150, Commodities Trading Platform 120 may determine performance metrics for an entity; define, detect, and execute arbitrage opportunities using metadata; and lock in profits between an underlying cash market and a futures contract.

Network 115 and network 125 can be the same network or separate networks and can be any combination of local area and/or wide area networks, using wired and/or wireless communication systems. Either network 115 or network 125 could be or could use any or more protocols/technologies: Ethernet, IEEE 802.11 or Wi-Fi, worldwide interoperability for microwave access (WiMAX), cellular telecommunication (e.g., 3G, 4G, 5G), CDMA, cable, digital subscriber line (DSL), etc. Similarly, the networking protocols used on network 115 and network 125 may include multiprotocol label switching (MPLS), transmission control protocol/Internet protocol (TCP/IP), User Datagram Protocol (UDP), hypertext transfer protocol (HTTP), simple mail transfer protocol (SMTP), and file transfer protocol (FTP). Data exchanged over network 115 and network 125 may be represented using technologies, languages and/or formats, including hypertext markup language (HTML) or extensible markup language (XML). In addition, all or some links can be encrypted using conventional encryption technologies such as secure sockets layer (SSL), transport layer security (TLS), and Internet Protocol security (Ipsec).

Various data stores such as data stores 140 and 145 can be used to manage storage and access to historical market data. The data stores may be a data repository of a set of integrated objects that are modeled using classes defined in database schemas. Data stores 140 and 145 may further include flat files that can store data. Commodities Trading Platform 120 and/or other servers may collect and/or access data from the data stores.

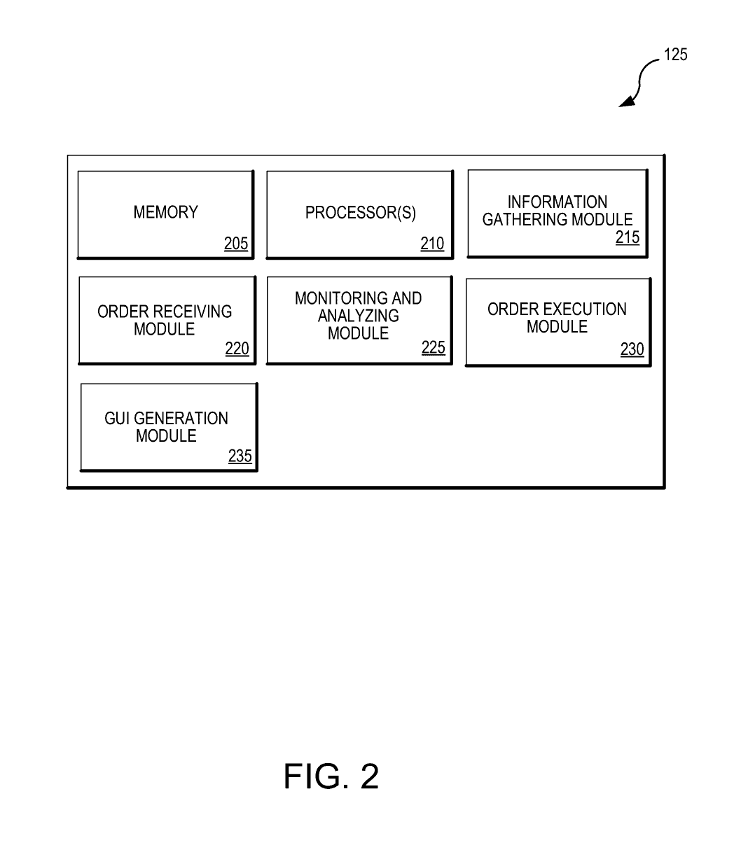

FIG. 2 illustrates a set of components within Commodities Trading Platform 120 according to one or more embodiments of the present disclosure. According to the embodiments shown in FIG. 2, the Commodities Trading Platform 120 can include memory 205, one or more processor(s) 210, information gathering module 215, order receiving module 220, monitoring and analyzing module 225, order execution module 230, and graphical user interface (GUI) generation module 235. Other embodiments may include some, all, or none of these modules and components, along with other modules, applications, and/or components. Still yet, some embodiments may incorporate two or more of these modules and components into a single module and/or associate a portion of the functionality of one or more of these modules with a different module.

Memory 205 can be any device, mechanism, or populated data structure used for storing information. In accordance with some embodiments of the present disclosure, memory 205 can be or include, for example, any type of volatile memory, nonvolatile memory, and dynamic memory. For example, memory 205 can be random access memory, memory storage devices, optical memory devices, magnetic media, floppy disks, magnetic tapes, hard drives, erasable programmable read-only memories (EPROMs), electrically erasable programmable read-only memories (EEPROMs), compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205.

Memory 205 may be used to store instructions for running one or more applications or modules on processor(s) 210. For example, memory 205 could be used in one or more embodiments to house all or some of the instructions needed to execute the functionality of information gathering module 215, order receiving module 220 and monitoring and analyzing module 225, order execution module 230, and GUI generation module 235.

Information gathering module 215 gathers information regarding commodities from a variety of sources, including financial and commodity exchanges, linkages to other trading venues (e.g., dark pools), global producers, global refiners, and global tradehouses/warehouses. Information gathering module 215 further gathers information regarding transportation of commodities from sources such as traders with vessel inventory; time charter owners; vessel owners; regional transportation providers of freight; rail, trucking, barge, and traders with pipeline capacity; and pipeline owners.

Order receiving module 220 receives orders from a trader for multi-dimensional trade. The order can include various parameters, including specific trading parameters that allow a trader to lock in profits. For example, the trader can state that the trader wants to buy the spread on a commodity when the spread reaches a certain level, so long as freight is below a certain amount for the commodity.

Monitoring and analyzing module 225 constantly monitors and analyzes the information gathered by information gathering module 215. Monitoring and analyzing module 225 can determine when the parameters of the trader's orders received by order receiving module 220 are met.

Order execution module 230 executes the orders when monitoring and analyzing module 225 determines that the trader's parameters have been met. Because the trade is multi-dimensional, various markets are connected that were impossible to connect prior to the Commodities Trading Platform 120.

GUI generation module 235 can generate one or more GUI screens that allow for interaction with a user. In at least one embodiment, GUI generation module 235 generates a graphical user interface receiving and/or conveying information to the user.

### Determining Performance Metrics Using Metadata

The Commodities Trading Platform can determine entity trading performance using metadata collected by the Commodities Trading Platform.

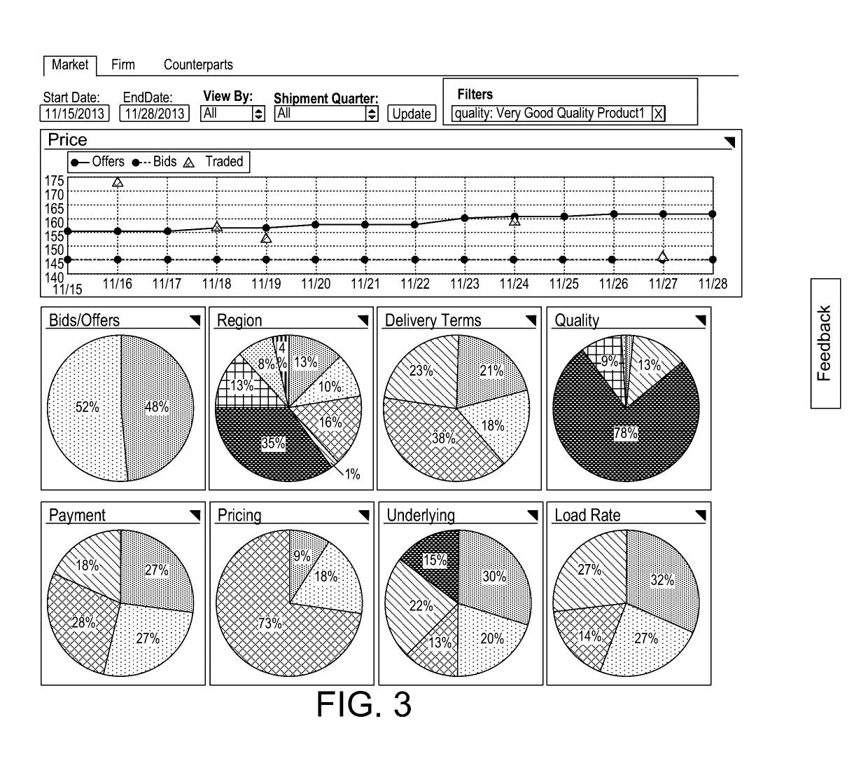

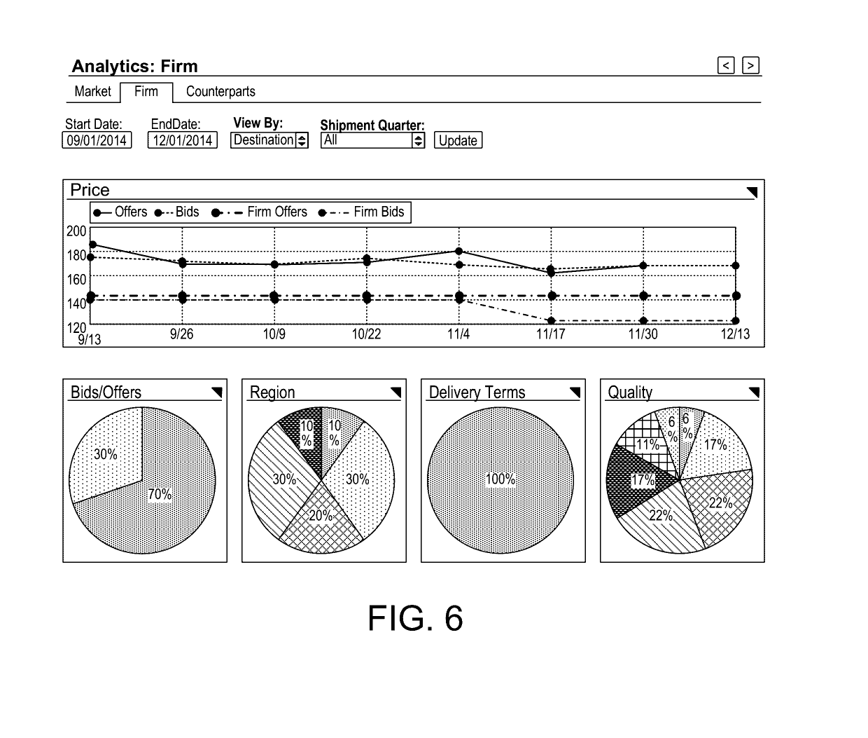

FIG. 3 illustrates a user interface of the Commodities Trading Platform showing a sample of general market data. As shown, the Commodities Trading Platform can display the price of offers, bids, and trades for various commodities within a selectable timeframe. Each negotiable field (quality, quantity, load rate, etc.) of a user's market order is stored in the system and is thus available for further analysis. The user can select to show all data, or the user can limit details if counterparts are not trade-enabled with one another. The data includes both real-time and historical data. Each line and pie chart can contain a triangle at the top right corner. If the user selects the gray triangle, the additional commodity data may be displayed. Additionally, enterprise bids and offers only (globally or by office) and individual trader activity can be displayed, which is further illustrated in FIG. 6.

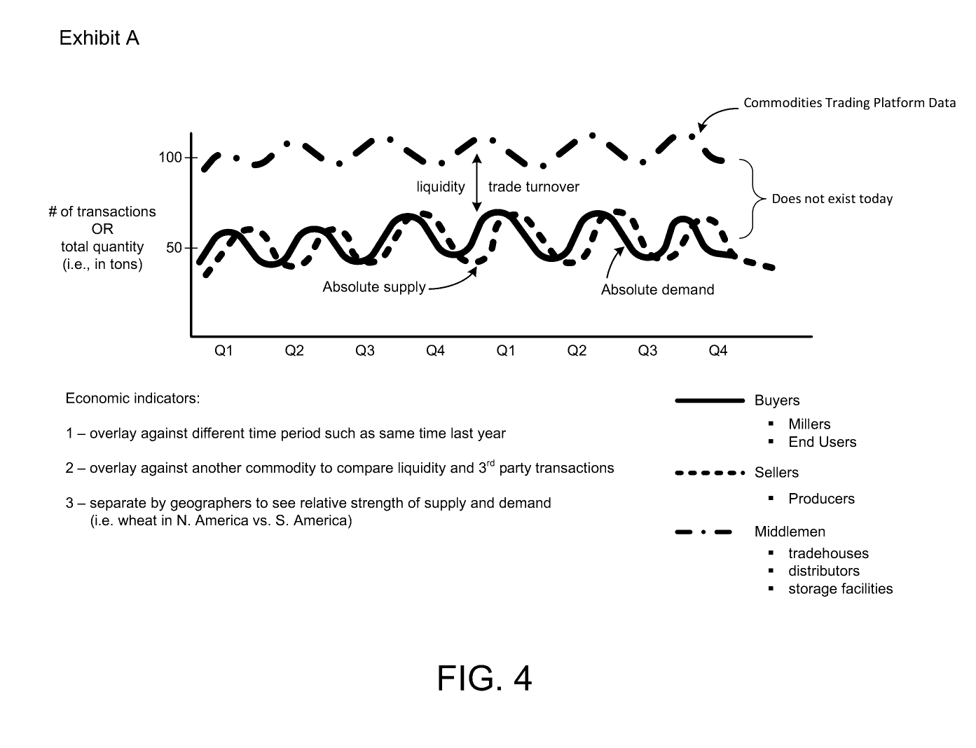

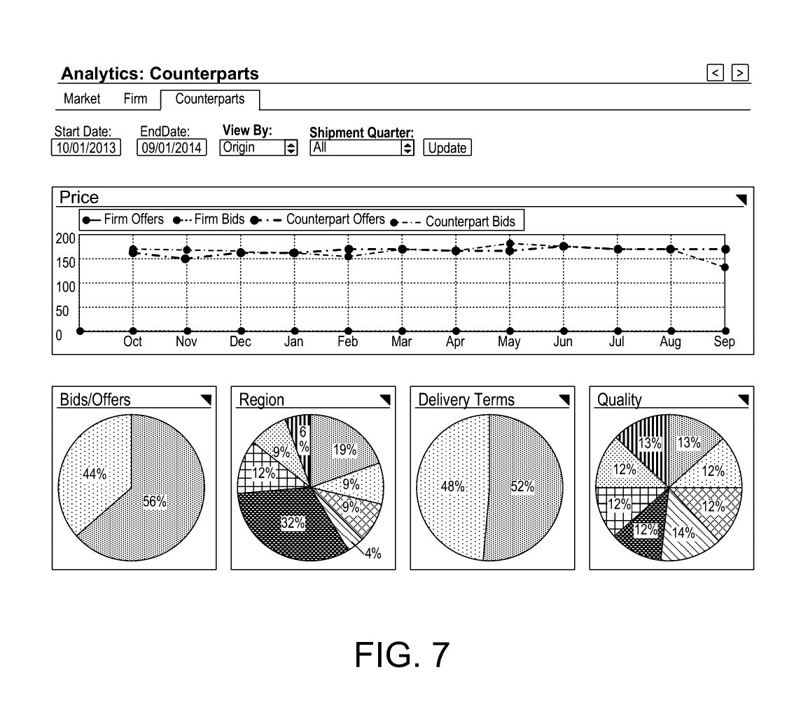

Counterpart eligibility may be shown, as further illustrated in FIG. 7. Additionally, all market orders are posted and labeled by user type. This type of information is nonexistent in current systems. For example, in agricultural and energy commodities, user types include producers, traders and/or warehousers, processors/refiners, or end users. Financial instrument analytics can similarly be described by user type (e.g., pension, hedge fund, or sell-side financial institution). Additionally, synthetic values and spread values may be determined and displayed. An example of the value of this information is shown in FIG. 4, which shows liquidity in the sugar market by separating the true supply and demand and the liquidity that the traders/warehousers supply. The chart shown in FIG. 4 can represent the number of transactions by actual quantity, geography, specific quantity, or other parameter of the systems' transaction over time (e.g., quarter). Economic indicators can be made more meaningful by comparing the chart to the same parameters from the same time of the prior year, comparing a chart of one commodity versus another, comparing the data from one geography to another to see relative strength and liquidity of the geography (or commodity).

Thus, the data can now be used to derive economic trends and indicators. For example, by charting the difference between market orders at origin and at destination, a synthetic cost of transportation can be derived. This chart can be used to predict whether actual prices of transportation will increase or decrease once the trade is realized in the market. Similarly, if a market were using the load rate feature, the data stored will serve as an indicator of future vessel demand (the larger the vessel, the faster the load rate). These analyses offer traders an unprecedented ability to lock in profit opportunities that usually occur between the trading of the physical contract on the Commodities Trading Platform and the execution of the contract (price hedging, booking actual transportation (if not already in the deal)). The Commodities Trading Platform provides the actual physical commodity trades far in advance of when it is shipped and put to use, which is a further example of unprecedented metadata. Thus, when the system offers trading of asphalt, cement, plywood or other building materials, it reveals where true supply meets demand and thus offers insight into the region's economic strength or weakness well before indicators of use (e.g., Housing Starts) are collected and published.

An arbitrage opportunity can occur between Commodities Trading Platform and, for example, an offline freight broker who is not aware that demand will be soaring for freight because of a recent increase in demand (e.g., six cargos just traded for the same time period). For example, if a commodity at origin is trading at $100 per ton and the same commodity is trading at $150 per ton delivered to the destination, the synthetic value of freight equals $50 per ton. The Commodities Trading Platform can detect (e.g., when a value dips below a certain point or trends a certain way within a specific time period) and users can see immediately that actual freight rates have begun to decline. Such data can signal and cause an execution of a trade to realize an immediate profit (e.g., continue to sell delivered to destination at $150 per ton and lock in freight at less than $50 per ton to realize (immediately) a profit on the transaction). In a second example, the Commodities Trading Platform detects an increasing number of bids for sugar in Santos, Brazil, with a load rate of 10,000 MT per day (typically, only large vessels can load 10,000 MT per day). This signals to the user that demand for larger vessels will increase, but usually not until the actual orders for shipping come to market (offline, freight is booked as needed, not far in advance). The user, knowing this information, uses it to book individual vessels as far in advance as possible to lock in lower prices, or even books vessels on time charter (exclusive lease) for multiple shipments. While futures instruments exist to hedge the price risk, the execution risk remains in the physical markets. The execution risks stem from distortions in local premiums due to supply and demand of the product or the transportation.

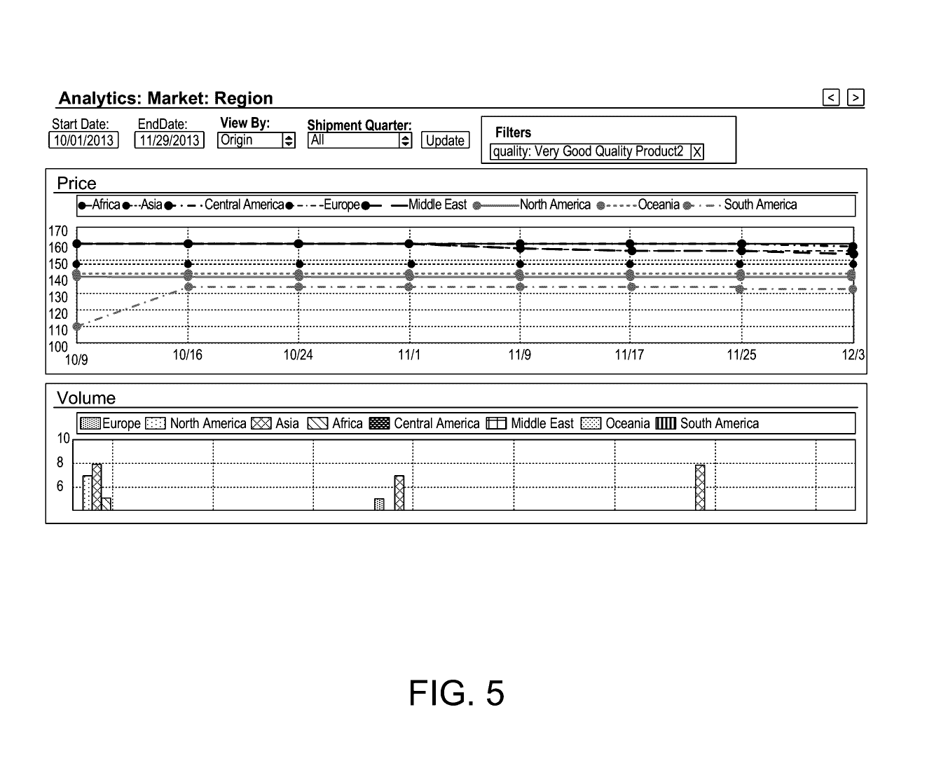

The Commodities Trading Platform may chart negotiable fields such as types of qualities of product (e.g., good, very good), geographies, payment terms, pricing terms, frequently chosen underlying rules, and vessel load rates. Such information can be used to create and define a new derivative contract such as a futures contract structured using common selections from each negotiable field. FIG. 5 illustrates a user interface showing market price analytics for a product by region, including volume data. An example of this is an overlooked market such as the byproducts of grain processing, or new oil and gas fields discovered via new horizontal drilling methods. As bids and offers for these products populate the screen, the system iterates the most commonly traded aspects of these (quality, quantity, delivery points and delivery windows) to define a futures contract. From there, many arbitrage opportunities exist with other contracts, such as swaps between the new contract and the next best futures contract, or a fixed/float swap for that commodity.

FIG. 6 illustrates a sample user interface showing the competitiveness of an entity in the marketplace. The user interface generated by the Commodities Trading Platform shows data filtered by time period (e.g., Sep. 1, 2014-Dec. 1, 2014), by entity (e.g., firm), and by destination (e.g., delivered) as it compares to the full market of bids and offers for the same time period and destination. Thus, the graph shown in FIG. 6 illustrates the competitiveness of the firm versus the rest of the market. This information can be used to evaluate opportunity costs and the performance of traders and risk managers. For example, the data may show that the firm or the trader (as filtered individually or collectively) is missing trading opportunities due to conservative prices. Or the data may show that the firm or trader is too quick to hit a bid or lift an offer. The Commodities Trading Platform not only aggregates what has traded historically, but also aggregates all bids and offers, thus revealing one's performance against the overall market.

FIG. 7 illustrates a user interface showing data by approved and blocked counterparts. Users of the Commodities Trading Platform can “approve” or “block” certain counterparties. The Commodities Trading Platform will only allow trades between counterparties who have approved one another for trading. Additional counterparties can be approved at any time. Thus, the Commodities Trading Platform allows users to filter bids and offers data by approved counterparties to assist with trading decisions. Additionally, this filtering assists larger firms by not allowing trades to occur between two different traders at the same firm.

The data shown in FIG. 7 assists users with assessing company risk tolerance. For example, a company may determine whether their conservative risk profile is costing the company too much in lost transactions by comparing the company's bids and offers with a counterparty's bids and offers.

### Defining, Detecting, and Executing Arbitrage Opportunities Using Metadata

The Commodities Trading Platform defines, detects, and executes arbitrage opportunities using metadata from the world commodity markets and the world transportation markets.

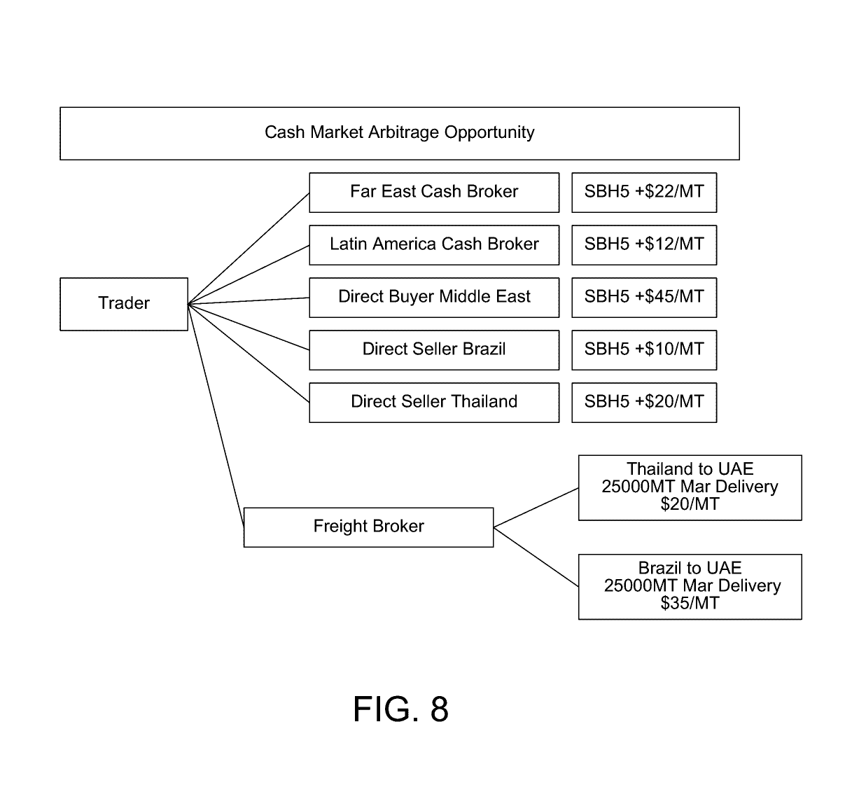

Because cash (physicals), transportation, and futures market prices do not change at the same pace, there are spread or arbitrage opportunities in which traders can lock in profits. The price discrepancy is referred to as a “spread.” Executing a spread is referred to as “legging the spread” because, prior to the Commodities Trading Platform, traders had to go to multiple sources to execute the spread, as shown in FIG. 8.

FIG. 8 illustrates how cash markets trade in prior art systems. In these types of systems, cash markets trade via phone, email, or other messaging services. As shown, the trader coordinates with various buyers and sellers in various parts of the world, attempting to determine a market price by, for example, calling, instant messaging, or emailing. However, determining a market price is difficult at best, if not impossible, under such conditions. Additionally, any market price that the trader believes to be determined is unverified.

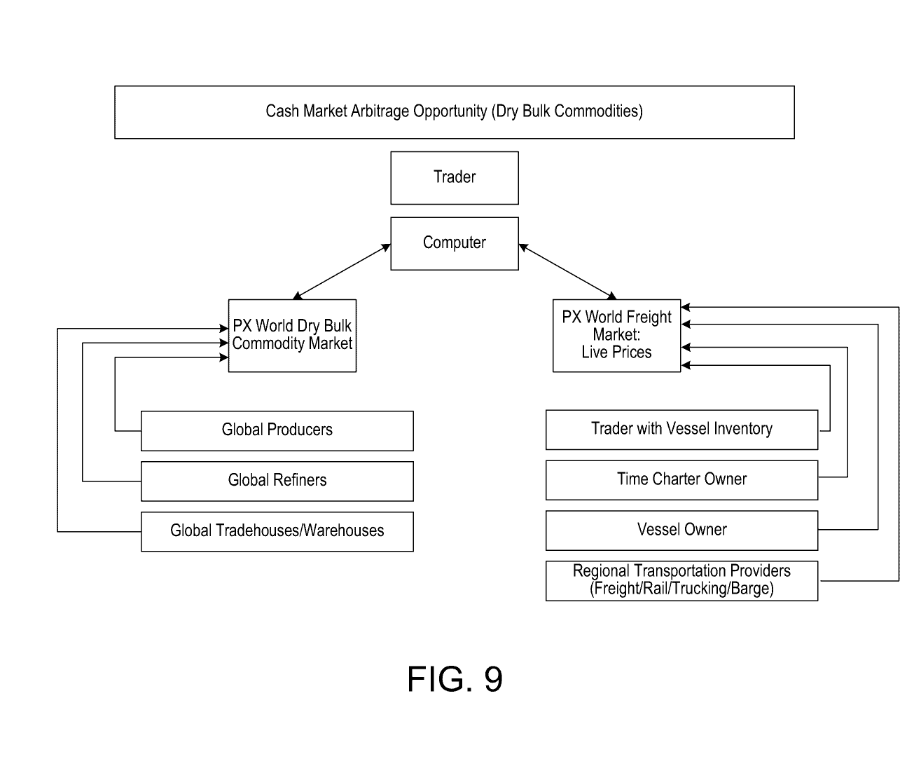

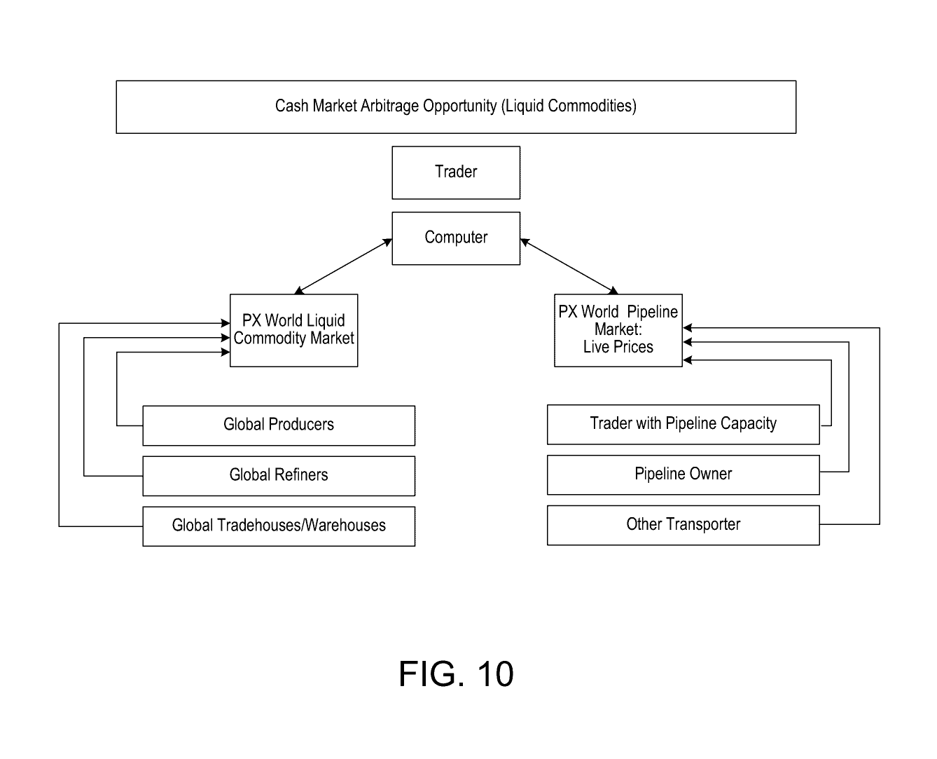

FIGS. 9-10 illustrate two examples of how cash markets trade using the Commodities Trading Platform. As shown in FIG. 9, the Commodities Trading Platform gathers market-wide commodity market data, in this case, for dry bulk world commodities and market-wide transportation market data for dry bulk world commodities. The commodity market data is gathered from market participants (via, e.g., computer systems, trading data, phone calls) such as global and regional producers, global and regional refiners, and global and regional tradehouses/warehouses. The data can be generated by the true supply and demand for the commodity, the freight, the futures, currency or other financial instrument. A trader can view live and historical worldwide commodity market data and market-wide transportation market data, input bids and offers, enable and block counterparties, and analyze data using various filters. In some embodiments, regional transportation providers are included (e.g., freight, rail, trucking, and barge). Such data, along with automated processes, allow traders to profit from spreads and avoid losses from spreads. The freight market live prices can be gathered from the dry bulk market (including the live prices from the Commodities Trading Platform and the prices found offline), freight brokers, time charter owners, and vessel owners. FIG. 10 is an example of how information is gathered and processed for liquid commodities (e.g., oil). For liquids, data can be gathered from traders with pipeline capacity, pipeline owners, or other transporters.

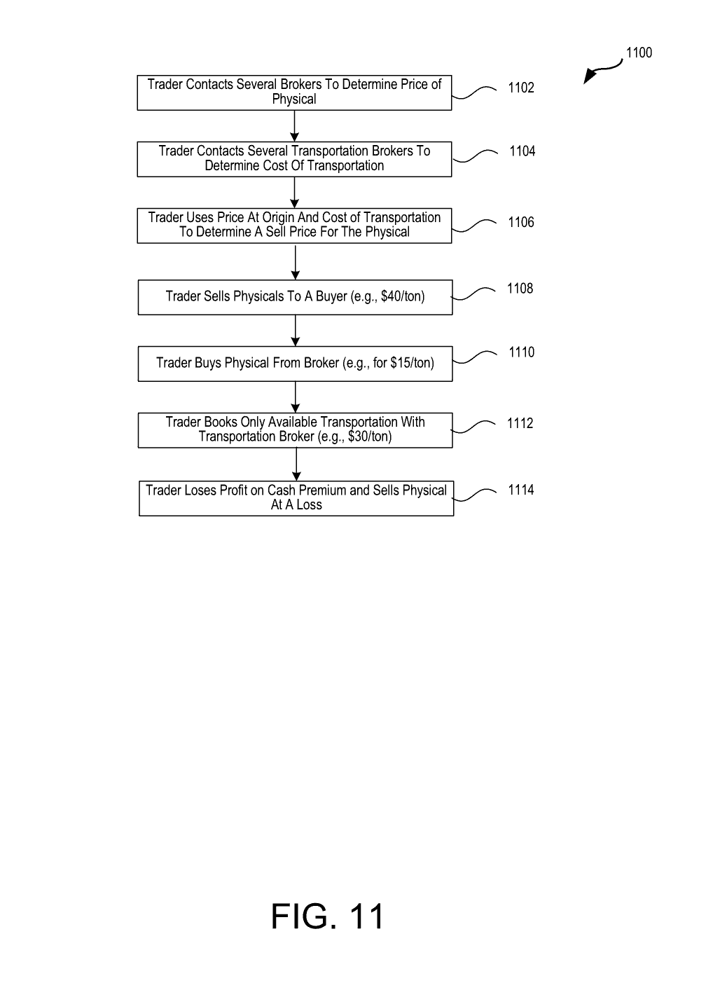

FIG. 11 is a flowchart illustrating how spreads are executed in legacy systems, without the Commodities Trading Platform. The example shown in FIG. 11 demonstrates the risk traders take by executing spreads without using the Commodities Trading Platform. In operation 1102, a trader contacts several brokers to determine the price of a physical (e.g., sugar) at one or more locations. In operation 1104, the trader contacts several transportation brokers to determine the cost of transportation of the physical to a certain location. Thus, after several phone calls, emails, or other communication, the trader determines a price at which to sell the physical in operation 1106 based on the price of the physical at origin and the cost of transportation, plus a premium. In this example, assume that the price the trader determines he should sell at is $40/ton. Next, in operation 1108, the trader sells the physicals for $40/ton at destination. At this point, the trader has not purchased the physical, nor has he arranged for transportation; however, the trader is obligated to deliver the physical to the buyer at the arranged place and time.

In operation 1110, the trader goes back to the broker who previously offered to sell the physical and negotiates a deal to purchase the physical. In this example, let's assume that the trader purchases the physical for the expected $15/ton. When the trader re-contacts the transportation broker, the trader is forced to book the only transportation available to make delivery in operation 1112. However, this transportation costs $30/ton. Thus, as illustrated in operation 1114, the trader loses any profits on the cash premium and sells the physical at a loss of $5 per ton.

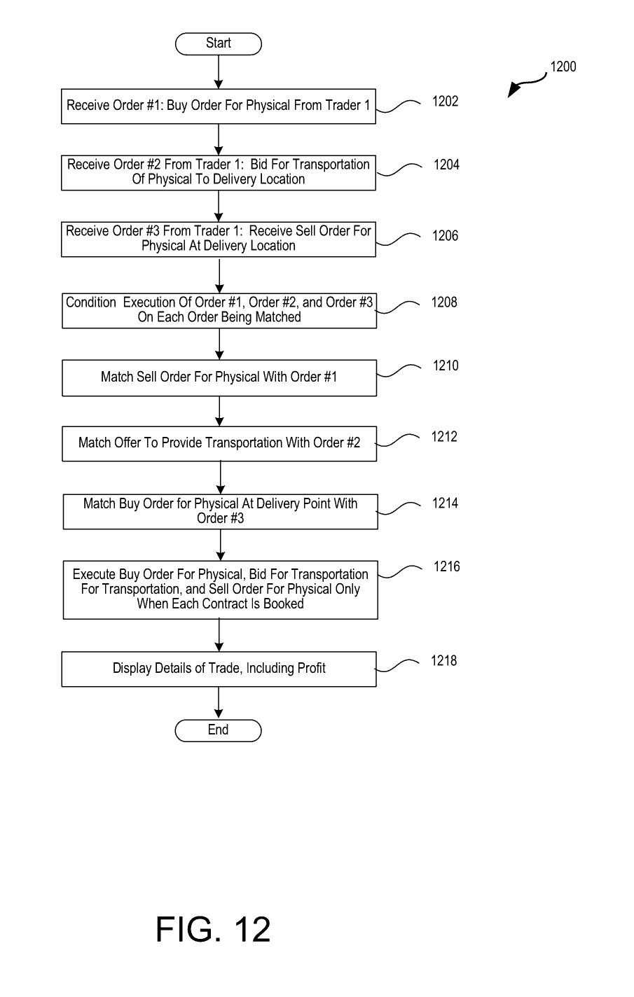

FIG. 12 is a flow chart illustrating how spreads are executed using the Commodities Trading Platform. By executing spreads conditioned upon each leg of the spread, PanXchange changes the landscape of executing spreads by removing risk of losing funds. Receiving operation 1202 receives at the Commodities Trading Platform a buy order for a physical. The buy order may specify a particular price, location for purchase, and quality. Receiving operation 1204 receives, from the same trader, a bid for transportation of the physical from the purchase location to a delivery location. Receiving operation 1206 receives, from the same trader, an order to sell the physical at a particular delivery location. Conditioning operation 1208 conditions the execution of the buy order for the physical, the bid for transportation, and the order to sell the physical on each order being matched. Matching operation 1210 matches a sell order from a third party with the trader's buy order for the physical. Matching operation 1212 matches a third party's offer to provide transportation with the trader's bid for transportation. Matching operation 1214 matches a third party's buy order for the physicals at the delivery point with the trader's sell order. After all three orders are matched, the orders are executed simultaneously in executing operation 1216. Displaying operation 1218 displays the details of the executed orders.

The process described in FIG. 12, which is impossible under previous regimes, allows a trader to set a profit margin and achieve the profit margin with no risk of losing funds in the transaction or guarantee known/specific profit upon booking. This example can be used to connect multi-dimensional trades such as one that ties different fungible markets such as a commodity and a transportation market, a commodity and a currency market, a financial instrument and a currency or interest rate market, a futures and a physicals market, or between two commodity markets such as a raw product and a refined product.

In some embodiments, the physicals order and the transportation order are tied together such that when the sum of the orders (i.e., the transportation costs plus the cost to purchase the physicals) equals a certain price, the orders can be executed automatically. For example, if the transportation costs fall dramatically, then the price of the physicals may go up the same amount while allowing the trader to achieve the same results. A user may set such acceptable differentials and execution parameters.

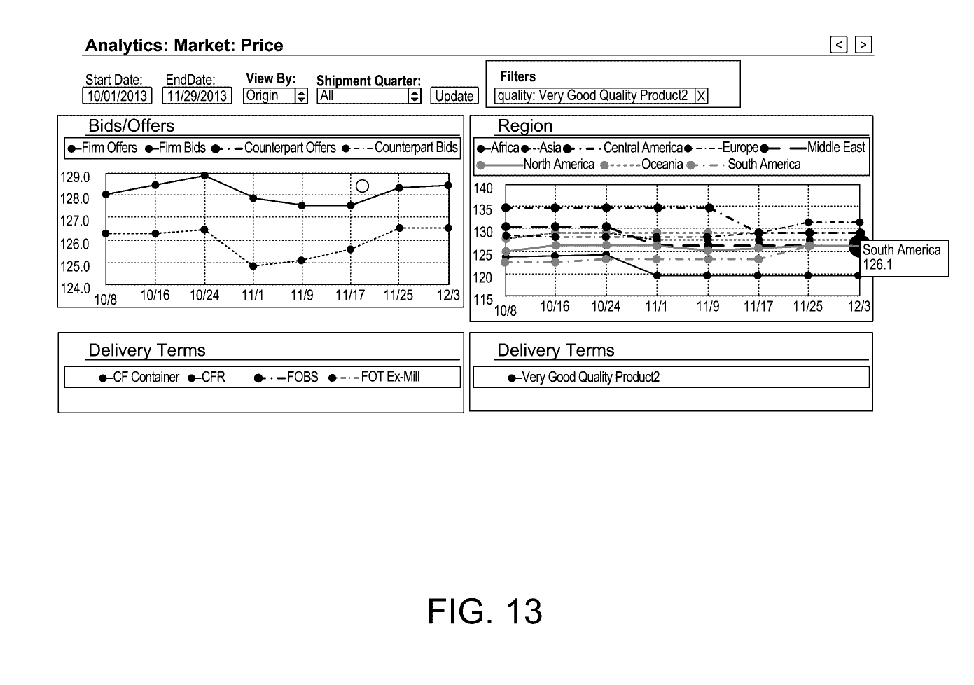

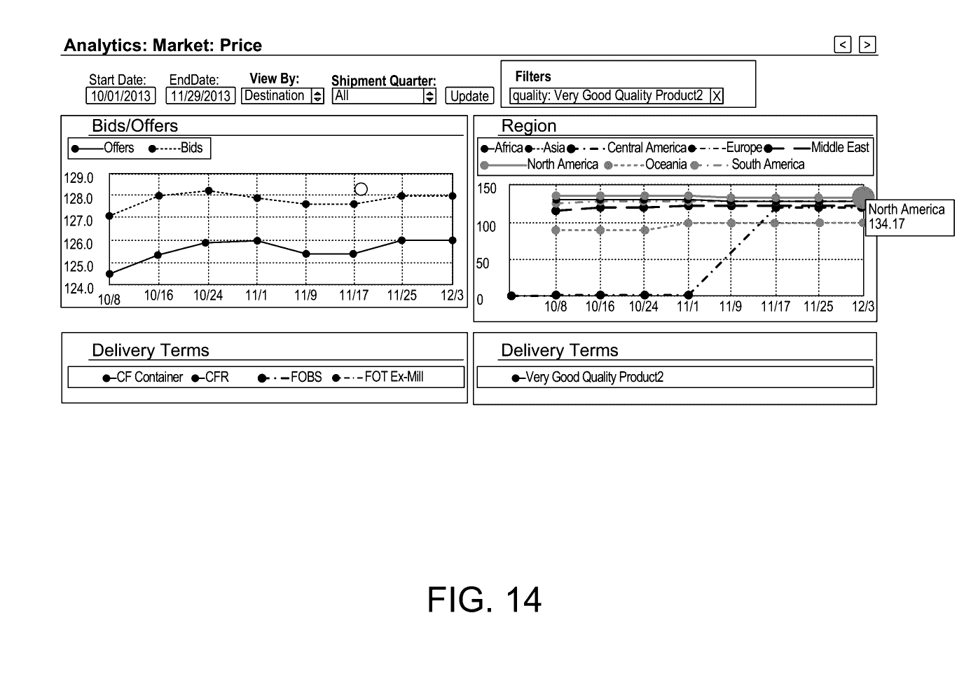

FIGS. 13 and 14 illustrate user interfaces that enable a trader to derive synthetic transportation spreads. FIG. 13 illustrates an example of market price analytics for a product at origin, and FIG. 14 illustrates an example of market price analytics for the product at destination. As shown, the price may be shown by bid and offer, region, delivery terms, and quality.

The live (actionable) and/or historical data points shown in FIGS. 13 and 14 can be used to: (1) lock in profit based on disparity between prices at origin and prices at destination (e.g., using the freight trading screen on the same system, as shown in FIG. 13) for example, if freight prices start to decrease, sales of the physical commodity at the destination should begin to decline. Traders can then sell the commodity at the destination before that happens, then lock in the lower freight rate and physical purchase at origin; and (2) detect and seize opportunities for disparities in transportation rates using synthetic transportation differentials (e.g., using data points on the cash market at origin and destination). Traders can also use disparity as an early warning signal that freight rates are rising or falling, and use the information to increase profits by negotiating sharper rates with freight traders/brokers that are only working offline.

By streaming live data from futures markets into the Commodities Trading Platform, similar types of arbitration may occur. For example, using the Commodities Trading Platform, the same type of definition, detection, and execution can be used to profit from a refining spread and/or a differential between a physicals market value and a futures contract, as described below.

### Locking in Profits Between an Underlying Cash Market and a Futures Contract

Using the Commodities Trading Platform, traders can take advantage of the spread between two delivery periods using both the cash and futures market. Without the Commodities Trading Platform, these transactions are risky and impossible to execute because the market moves very quickly. Thus, the trader may only “leg” one side of the transaction before the market corrects, whereas using the Commodities Trading Platform, the first leg will not be executed without the second. The ability to define, detect, and lock in profitability has even more application in energy and other products that are traded/quoted against a strip of calendar contracts (the opportunity lies in the spread between the average of the included month's strip and an individual futures contract). The following is an example of how Commodities Trading Platform can be used to lock in profits between an underlying cash market and a futures contract.

Assume that today, a March NY11 contract, which is a futures contract on the ICE exchange in New York, where the contract month is March, is 15 cents or $330.70/ton and that a May NY11 contract is 16 cents or $352.74/ton. In the following example, H and K signify the futures contracts for March and May, respectively. SB indicates the ICE market for raw sugar and SW indicates the LIFFE market for refined sugar. Thus, SBH5 represents the ICE raw sugar contract for March 2015 and SBH6 is the March contract for 2016.

The trader purchases a cargo of sugar at origin in Brazil (A). Shipment is for March 1 through May 15, so the futures contract the trader uses is March (SBH5). The cargo includes 25,000 MT at a 20 point premium ($4.40/MT) for a total contract price of $330.70+$4.40 per ton or $8,322,500 (Columns 1 A & B). To hedge the price, the trader sells March futures for a total of $8,267,500 (Column 2 B), which leaves the trader exposed only to the $4.40 cash premium.

Soon, the trader begins to worry that demand is falling. He hopes for a near term spike in futures since there is very little demand in the physicals. He instructs the Commodities Trading Platform to buy the futures spread when the March/May futures spread decreases to less than 0.50 basis points ONLY IF he can sell the physical cargo of sugar for a 5 point premium to the May contract (with an immediate hedge in the May futures). He does so at 20 points on the spread (Column C).

Assume that the drop in physical demand catches up. There are no buyers for sugar against the March contract and a few buyers will bid against the May contract, but only at par (May plus $0). May futures decline to 15.50 cents. The trader would have definitely lost money without the spread order on PanXchange. It appears that the trader lost money since he bought at a $4.40/ton equivalent and sold it for only a $1.10 equivalent. However, looking at Table 1, he still made money because PanXchange was able to lock in the spread at the same time as the cash sale.

TABLE 1

| Trans- | | | | |
|---|---|---|---|---|
| action | | | | |
| With | | | | |
| the | | | Transaction | |
| Com- | | | without the | |
| modities | | | Commodities | |
| Trading | | | Trading | |
| Platform | | | Platform | |
| A. Cash | −$55,000 | | −$55,000 | |
| Premium | | | | |
| Purchase | | | | |
| B. Hedge | −$8,267,250 | $8,267,500 | −$8,267,250 | $8,267,500 |
| March | | | | |
| (sell) | | | | |
| C. Spread | −$8,708,170 | $8,818,400 | | |
| (buy | | | | |
| March | | | | |
| 15.80 sell | | | | |
| May 16) | | | | |
| D. Cash | | $27,558 | | $0 |
| Premium | | | | |
| sale | | | | |
| E. Hedge | −$8,542,825 | $8,542,825 | −$8,542,825 | $8,542,825 |
| Total | −$25,573,245 | $25,656,283 | −$16,865,075 | $16,810,325 |
| Net | | $83,038 | | −$54,750 |

In this example, the trader used the Commodities Trading Platform to take advantage of a short-term futures disparity to profit $83,038. Without it, he would have lost $54,750. Spread disparities, like the spike of March against the May futures, happen very quickly. The Commodities Trading Platform allows traders to lock in the futures activity with the cash activity, an opportunity which otherwise would have been lost.

### Locking in Profits Between Raw and Derivative Products (e.g., Refining Spreads)

The Commodities Trading Platform can capitalize on arbitrage opportunities when there is a cash market for both the underlying commodity and its byproduct or its refined state and at least one futures contract. For example, there are opportunities between raw sugar and refined sugar. Opportunities also exist in energy markets with crack spreads, spark spreads, crush spreads, frac spreads (i.e., spreads between natural gas and crude oil and their derivative products). Additionally, traders could hedge on the margin between a fertilizer, seed, or other crop input and the sale of the output.

To take advantage of the spread opportunities, traders can execute a buy order of the physical spread when the future market spread widens to a certain level. Using the Commodities Trading Platform, the trader can lock in both sides, thus not only avoiding the legging risk of hedging the physicals but also locking in a profit on the hedge.

The following is one example of how the Commodities Trading Platform can be used to profit from refining spreads. Raw sugar trades at a premium to the Intercontinental Exchange #11 contract, which is the contract that defines the terms for bulk raw sugar. Deliverable refined sugar will trade against the London International Financial Futures and Options Exchange #5 contract, which is the contract that defines the terms for refined sugar. The Commodities Trading Platform can be configured to alert and/or to take certain trading actions should the difference between the two futures contract fall below a certain price (e.g., $100/MT). Similarly, the Commodities Trading Platform can be configured to sell physical sugar when the spread is over a certain amount (e.g., $110/MT) or buy raw sugar at origin when the spread is lower than a certain amount (e.g., $95/MT).

The following is a second example illustrating how traders can profit from a refining spread of physical sugar using the Commodities Trading Platform. Assume a trader has an agreement with a sugar refinery to take the trader's raw sugar and refine it for $75/ton. This is the average market rate. The trader is obligated to process at least 25,000 MT per month but demand is very weak and only trading at an equivalent of $70 over raw sugar prices (SBH5), which is at par ($0) to the SBW5 contract.

If it were not for the Commodities Trading Platform, the trader would have to sell the refined sugar at a loss as follows: the trader can only sell refined sugar at par to refined sugar futures (SWH5=$400.70). The trader buys raw sugar at the going rate of $4.40 premium to raw sugar, which is now trading at 15 cents/lb or $330.70. Then the trader has to pay the refining margin of $75/MT for a total loss of almost $2 Million. With PanXchange, however, the trader knows the trader's obligation to refine sugar every month at $75/MT, so the trader puts a spread order in very early and hopes for an arbitrage opportunity that means that raw sugar will fall and/or white sugar will rise so that the differential is $80 per ton. The order is as follows: when the SBH5 and SWH5 spread is $80/ton or more, sell physical refined sugar at a $5 premium to the refined futures market: (A) buy raw sugar at a $4.40/MT premium to the raw sugar contract, (B), sell the futures spread to lock in the $80 differential (C) pay the refining margin and (D) deliver the physical sugar.

Two things to note: in this example, as shown in Table 2, the trader not only made $138,000, but avoided a potential loss of over $2 Million. Further, because these transactions are all happening simultaneously, the hedges displayed are really not necessary—both “hedge” rows cancel each other out, leaving only the cash premium risks. This also saves on futures market transaction costs and avoids funds getting tied up in margin accounts.

TABLE 2

| | | | Transaction | |
|---|---|---|---|---|
| | | | without the | |
| Transaction with the | | | Commodities | |
| Commodities | | | Trading | |
| Trading Platform | | | Platform | |
| Sell refined sugar | | | | |
| for pick up at | | | | |
| refinery at | | | | |
| SWH5 = $5/MT (A) | | | | |
| Cash premium sale | | $125,000 | $0 | $0 |
| Hedge | −$10,017,250 | $10,017,250 | −$10,017,250 | $10,017,250 |
| Buy raw sugar | −$110,000 | | −$110,000 | |
| SBH5 + $4.40 (B) | | | | |
| Hedge | −$8,019,233 | $8,019,233 | −$8,267,250 | $8,267,250 |
| Sell the spread | | | | |
| Buy SBH5 | | $10,017,250 | | |
| Sell SWH5 (C) | −$8,019,233 | | | |
| Refining cost (D) | −$1,875,000 | | −$1,875,000 | |
| Total | −$28,040,715 | $28,178,733 | −$20,269,500 | $18,284,500 |
| Net | | $138,018 | | −$1,985,000 |

Moreover, traders can use the Commodities Trading Platform to overtake the competition in markets such as procuring crude. For example, the trader can set up a series of orders selling gasoline or other refined product to sell at a high price because the trader can pay above average prices for the crude, since the refining margin has been locked in.

Because the Commodities Trading Platform is linked to futures markets, such a deal can be established in the cash market, futures market, transportation market, or any combination thereof. In some embodiments, the deal is also linked to currency markets or other markets for financial hedging such as dark pools or other closed exchange systems. Current systems do not allow for this type of profit to be guaranteed due to the numerous points of contact to leg each piece of the whole program.

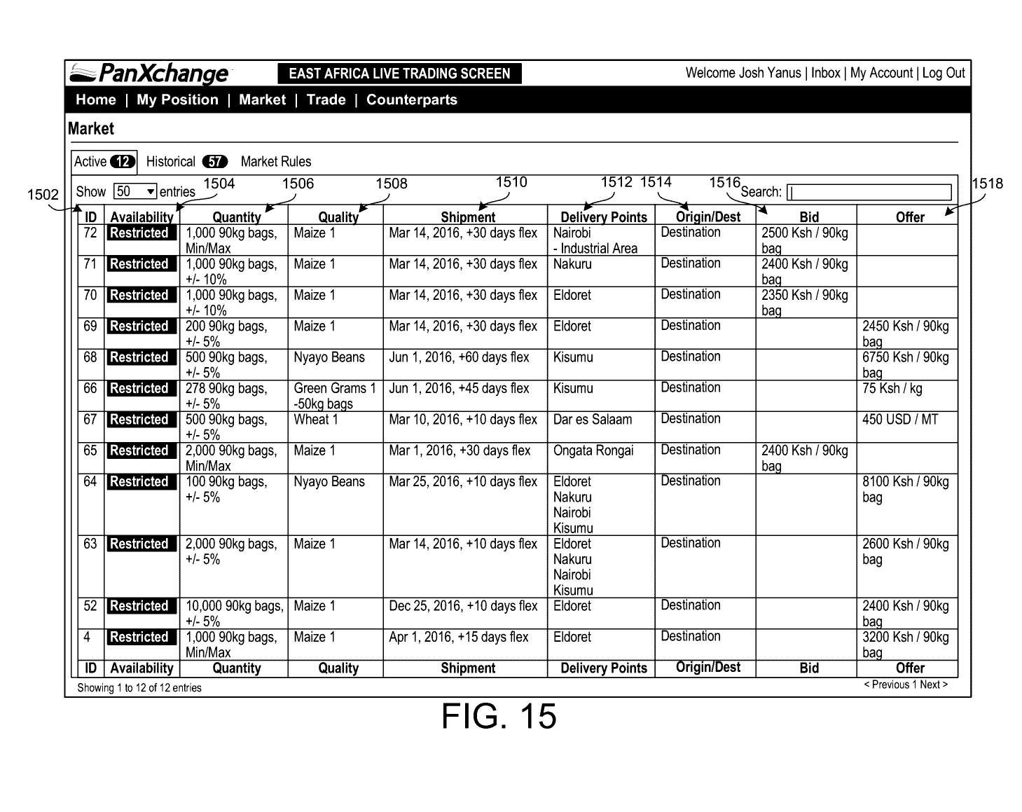

FIG. 15 illustrates a user interface showing an example of a live trading screen with bids and offers. The trade identifier is listed (1502). The availability of the order is shown and is set by the user who has identified which of the computer system groups' members s/he will trade with. If the order is indicated as “Available”, the trader could open the order to accept it or negotiate against it. (1504). The quantity in which the seller is selling or the buyer is seeking is listed (1506). The quality is of the commodity is further listed (1508). A shipment date can be shown, along with a number of days the shipment date is flexible (1510). One or more delivery points can be specified (1512), and the delivery point can be specified as an origin or a destination (1514). If the order is a bid for commodities, the bid can be specified (1516). If the order is an offer to sell commodities, the offer can be specified (1518).

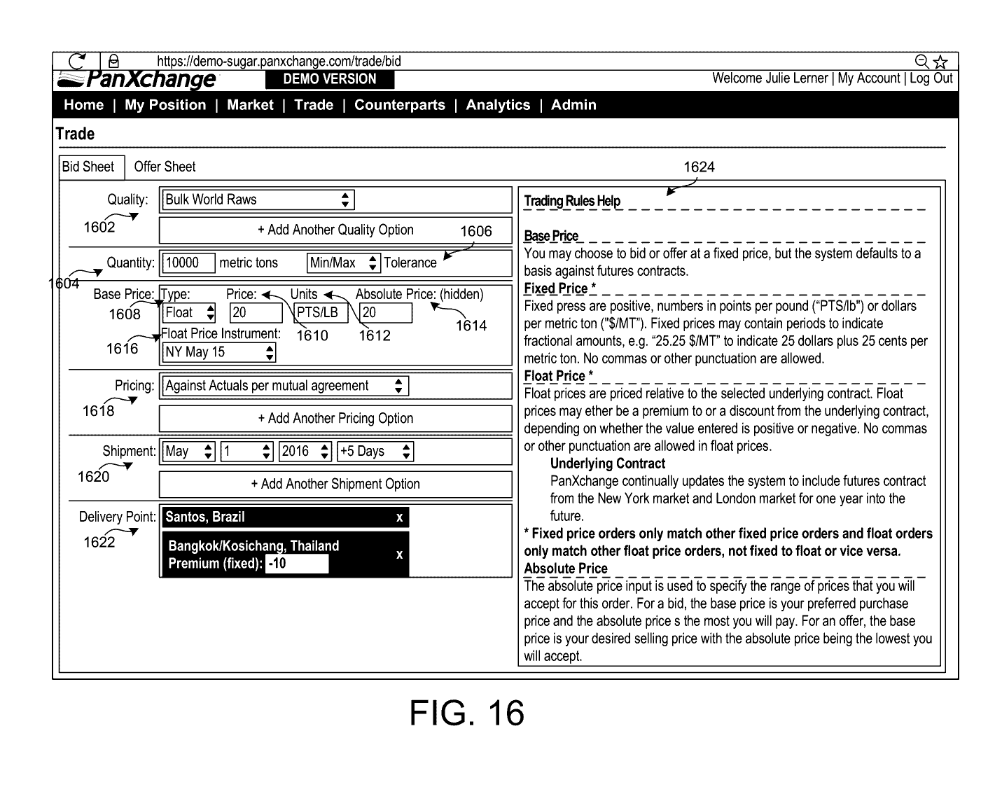

FIG. 16 illustrates a user interface showing a partial example of a bid sheet for a user to input a bid. The user can specify a quality (1602), quantity (1604), quantity tolerance (1606), type of price (i.e., fixed or float) (1608), price (1610), units (1612), an absolute price (i.e., the range of prices that the user will accept for the order, that is, the highest price the user will go for a bid and the lowest price the user will go for an offer) (1614), float price instrument (1616), pricing (1618), shipment (1620), and delivery point (1622). Definitions for pricing are provided on the right portion of the user interface (1624). The “Add another . . . ” feature allows users to truly negotiate. For example, a user can designate “May 1 2016 plus 5 days” as the shipment window and add a second shipment window of “April 1 plus 5 days.” The GUI of the Commodity Trading Platform can include the “adds another” feature which specifies that the current order (FIG. 16) be linked to one or more orders that will not execute unless the other orders in the series are matched. When the user “adds another,” the system links the orders to the other orders. By allowing users to “add another,” the orders are linked together and the series of orders that are linked will not execute unless the other orders in the series are matched.

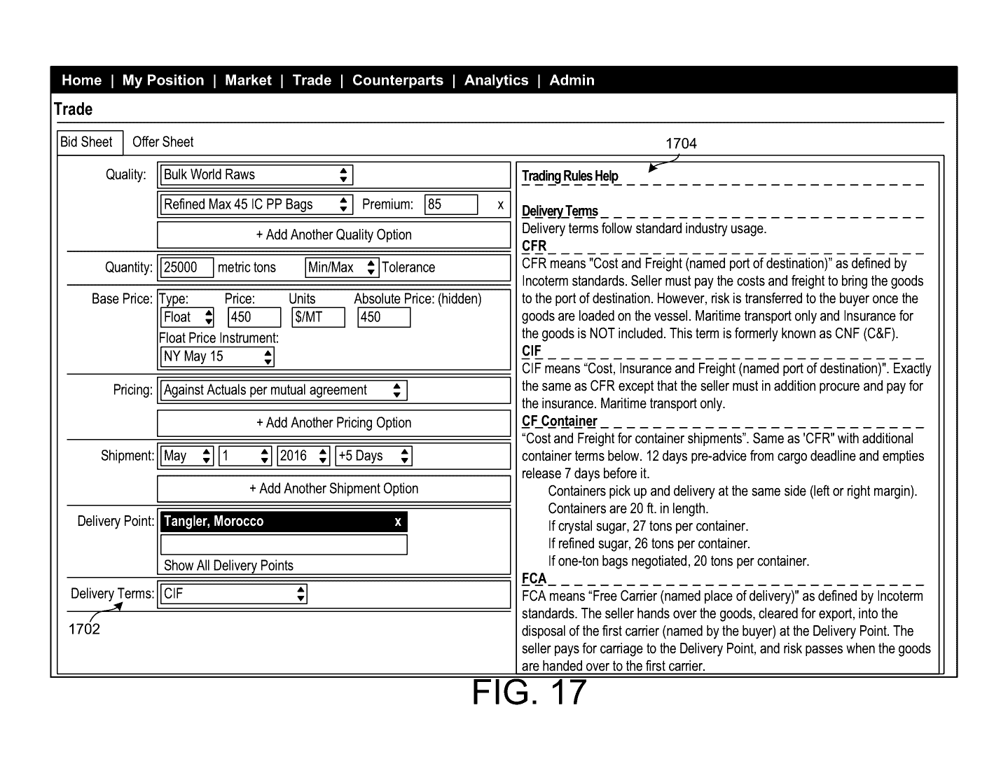

FIG. 17 illustrates a user interface showing an example of a partial bid sheet for a user to input a bid. FIG. 17 is similar to FIG. 16 and further shows that delivery terms may be specified (1702). Definitions for the various delivery terms are provided on the right portion of the user interface (1704).

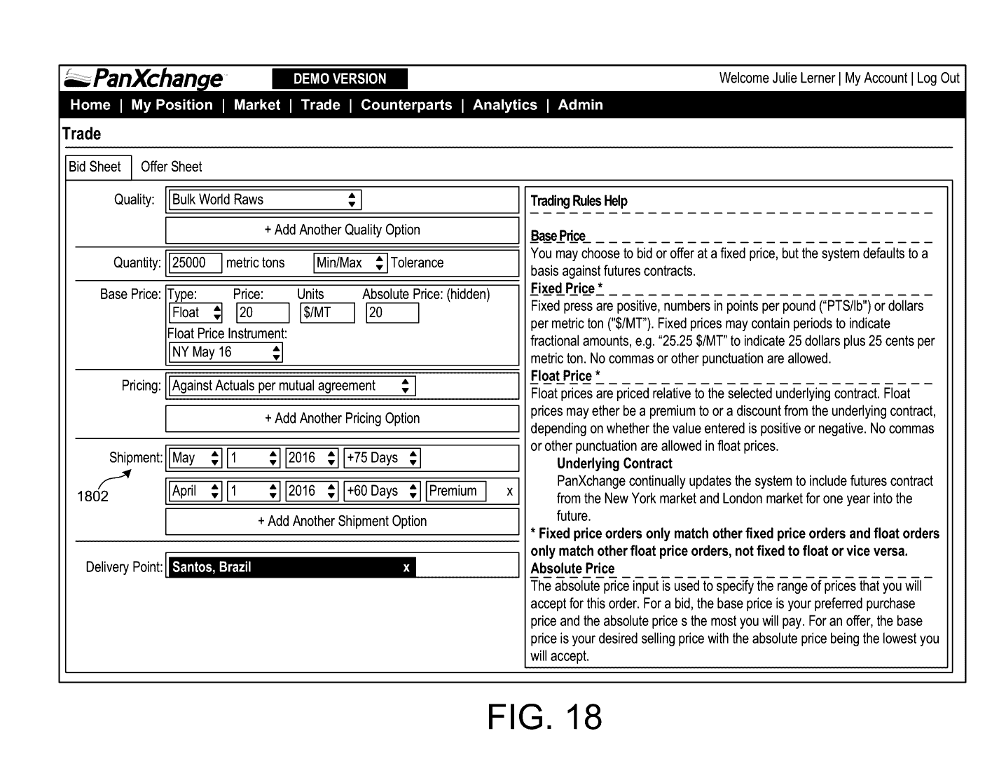

FIG. 18 illustrates a user interface showing an example of a bid sheet for a user to input a bid. FIG. 18 is similar to FIG. 16 and further shows that the user can select multiple shipment dates but include a premium or discount reflecting whether or not the second shipment date is preferred to the first or less desirable than the first (1802). Again, the “add another . . . ” feature links the orders to the other order. In an example, if the user was creating an offer to sell, the user could select an origin point of Santos, and then add Dubai for an additional $50/ton if their purchase of bid for freight from Santos to Dubai is also matched.

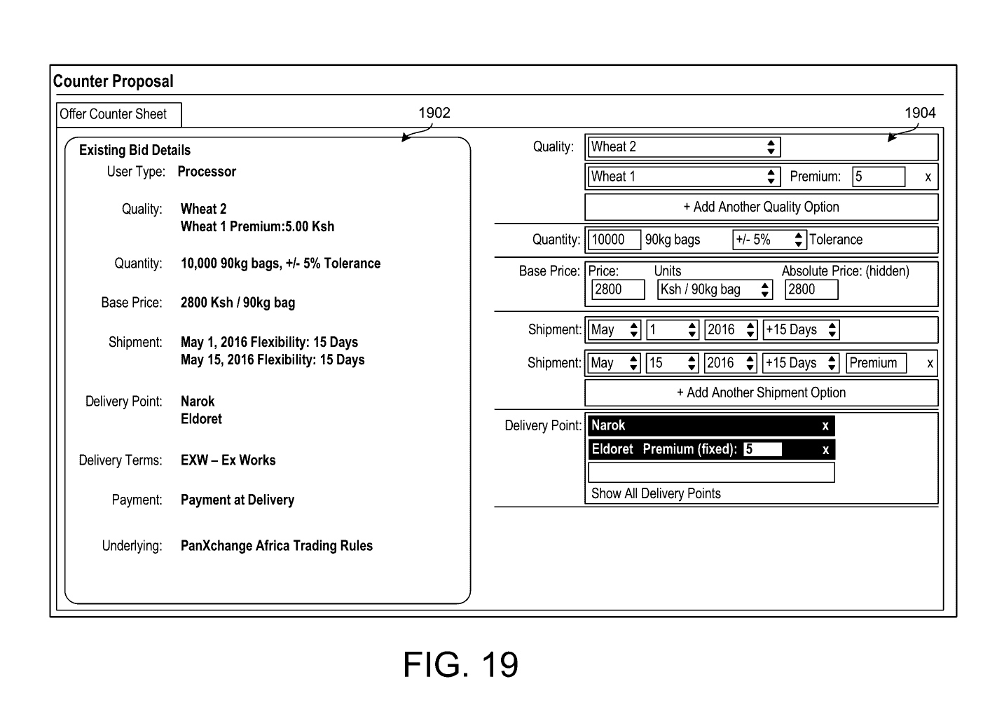

FIG. 19 illustrates a user interface showing an example of a counter offer sheet. On the left portion of the user interface, the existing bid details (e.g., quality, quantity, base price, shipment, delivery point, delivery terms, payment, underlying rules) are shown (1902). On the right portion of the user interface, the user can change one or more of the existing bid details to provide a counteroffer (1904).

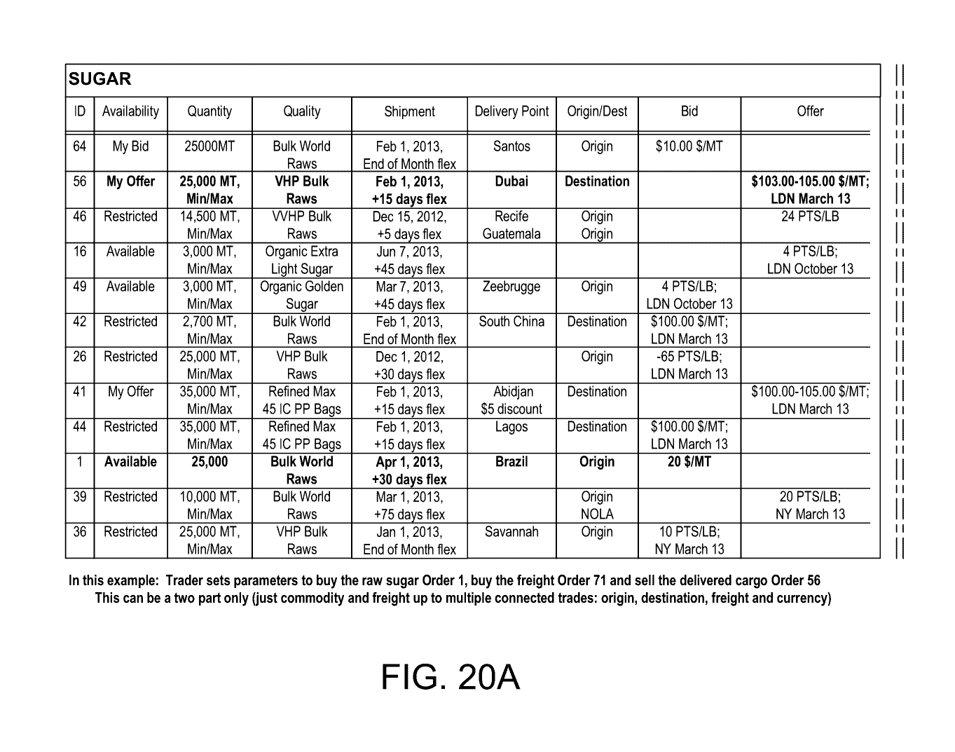

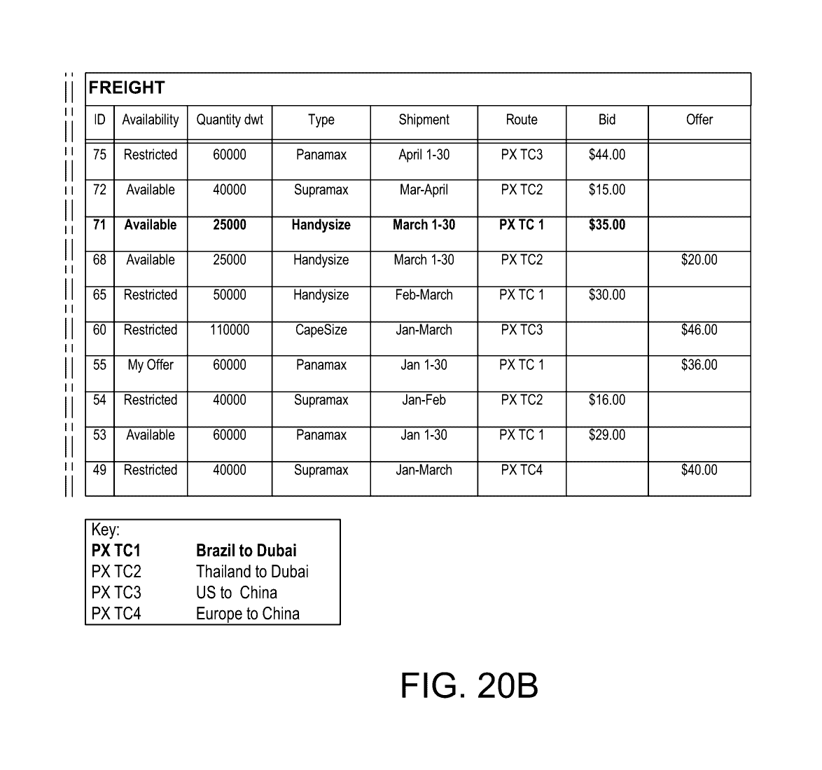

FIGS. 20A and 20B illustrate an example of a trader setting parameters for a trade that is contingent upon a transaction in another market. In this case, physical sugar and dry bulk freight. For example, the trader sets parameters to purchase raw sugar (order 1), purchase the freight (order 71), and sell the delivered cargo (order 56). The system uses, for example, if/then parameters to ensure that each side of the order is matched before executing any one side of the order. Each side of the order runs through each field to confirm a match, and, before execution, the last parameter that is confirmed is whether the one or more other connected orders are matched and ready to be executed as well. In some implementations, the connected trades can be a two-part only (e.g., just commodity and freight) or the trades can be multiple connected trades (e.g., origin, destination, freight, currency).

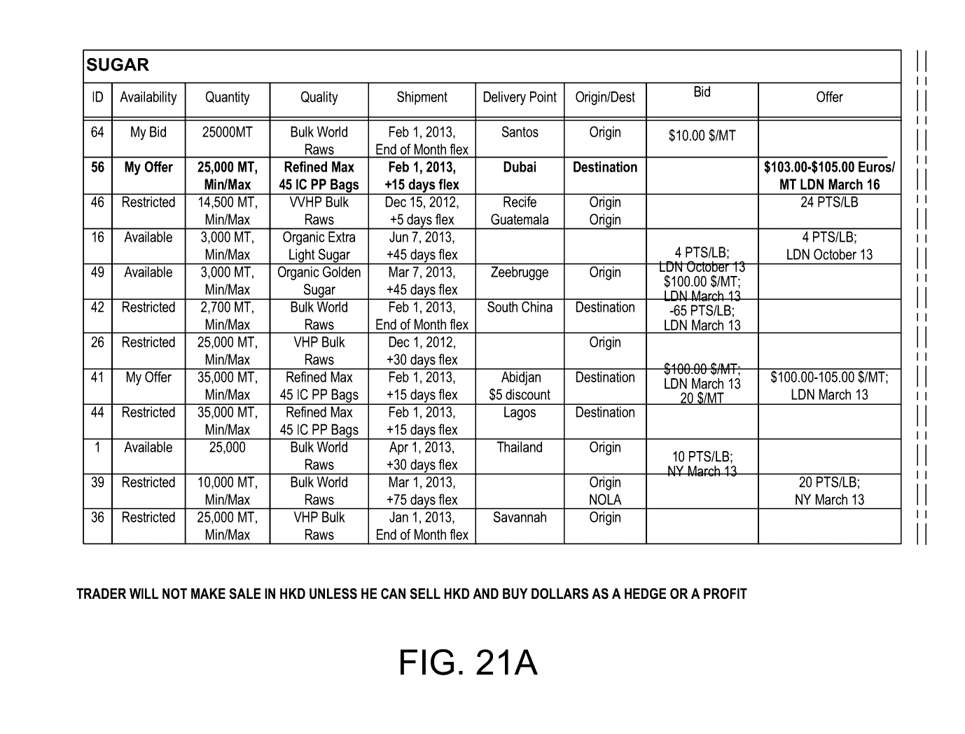

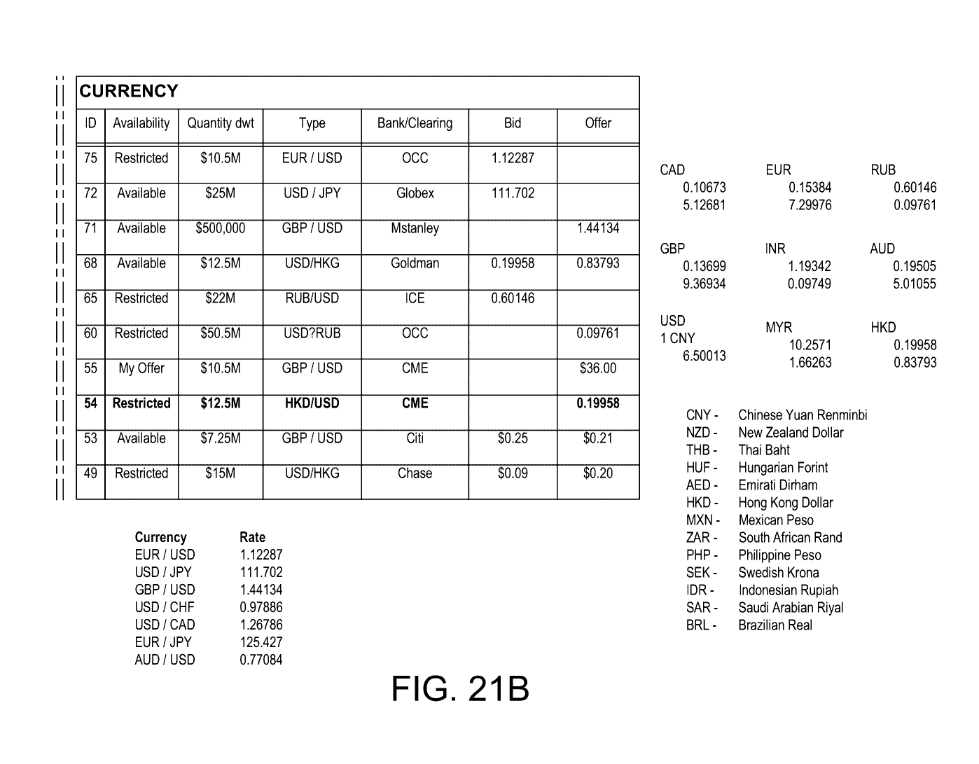

FIGS. 21A and 21B illustrate an example of a trader setting parameters for a trade. The trader can set parameters such that the trader will not sell the sugar in Euros (order 56) unless he can sell the Euros and buy US dollars (order 75 FIG. 21B) as a hedge or profit.

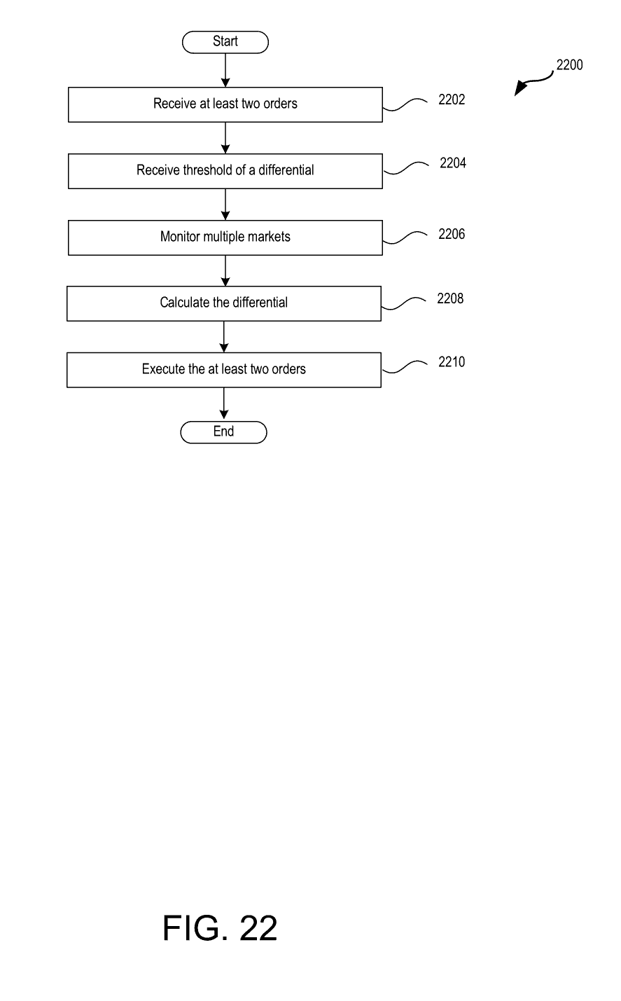

FIG. 22 is a flowchart illustrating an example of locking in arbitrage using the Commodities Trading Platform. Receiving operation 2202 receives at least two orders relating to a physical commodity. The orders can be linked such that each order in executed simultaneously without user interaction when each order is matched. Receiving operation 2204 receives a threshold of a differential between an aspect of the physical commodity. The aspect can be a negotiable field of a market order such as the cost of transportation of the physical commodity, the price of the physical commodity, the contract period to buy or sell the physical commodity, and a contract price to buy or sell the physical commodity. In some embodiments, the price of the physical commodity may include a difference in currency prices. Monitoring operation 2206 monitors multiple markets relating to the physical commodity (e.g., transportation markets, currency markets). Calculating operation 2208 calculates the differential between the aspect based on the information provided by monitoring operation 2206 and determines when the differential has reached the threshold. When the first differential has reached the threshold and when each order has been matched, executing operation 2210 executes the orders simultaneously without user interaction.

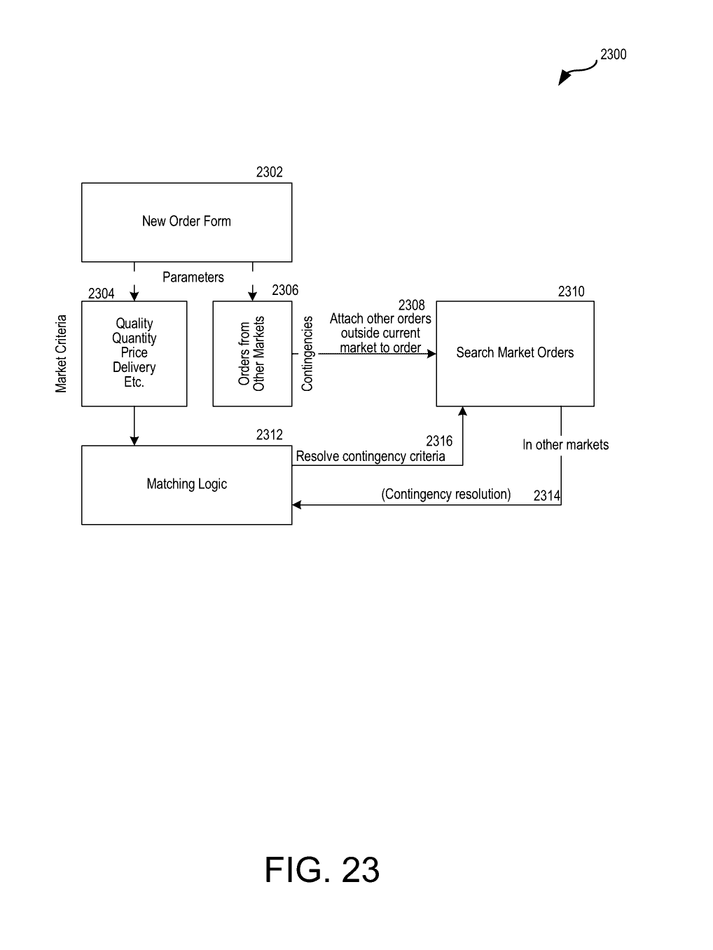

FIG. 23 is a flowchart illustrating an example of how orders are simultaneously executed. New order forms are received via the system (2302). The new orders can include various market criteria (e.g., quality, quantity, price, delivery) (2304), which is sent to a matching engine with matching logic to be matched (2312). The order form searches for contingencies that exist outside of the current market (2316).

The order can further specify contingency orders from other markets (e.g., freight market) (2306). The order and the contingency orders are linked together (2308) and sent to a searching engine where market orders are searched (2310). The searching engine sends market orders to the matching engine (2314). In any market, when an order is submitted with a contingency, the order runs through the matching logic of other markets. The flowchart shown in FIG. 23 can be bi-directional based on where the new order is originating and can determine if orders outside current markets would match the contingency criteria.

### Computer System Overview

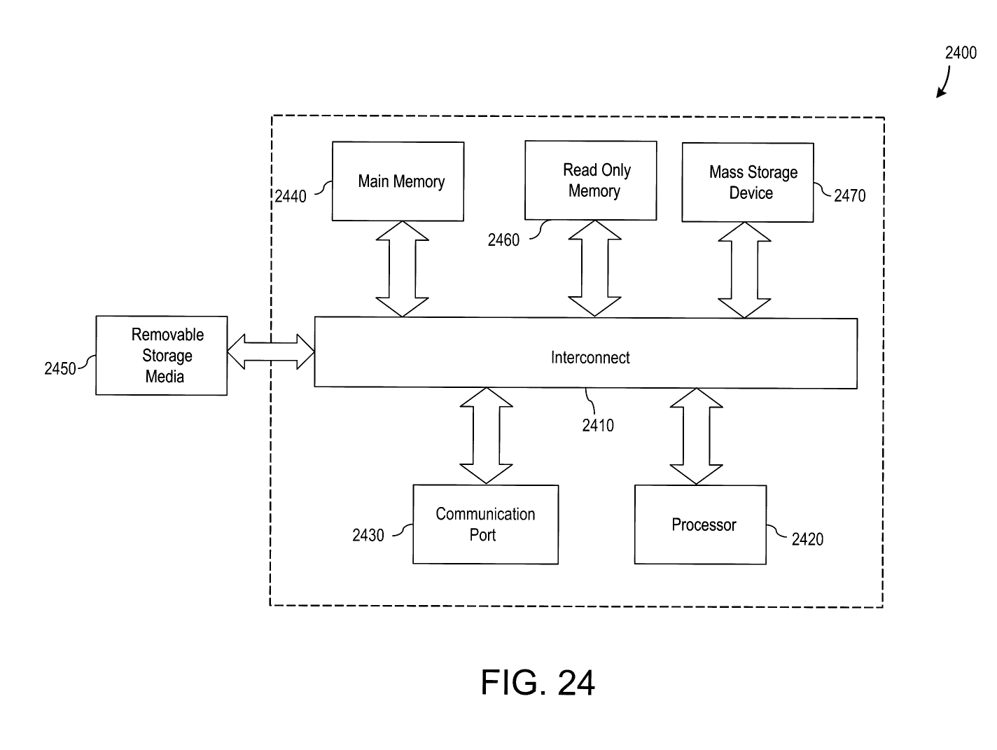

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 24 is an example of a computer system 2400 with which embodiments of the present disclosure may be utilized. According to the present example, the computer system 2400 includes an interconnect 2410, at least one processor 2420, at least one communication port 2430, a main memory 2440, a removable storage media 2450, a read-only memory 2460, and a mass storage device 2470.

Processor(s) 2420 can be any known processor. Communication port(s) 2430 can be or include, for example, any of an RS-232 port for use with a modem-based dial-up connection, a 10/100 Ethernet port, or a Gigabit port using copper or fiber. The nature of communication port(s) 2430 may be chosen depending on a network such as a Local Area Network (LAN), Wide Area Network (WAN), or any network to which the computer system 2400 connects.

Main memory 2440 can be random access memory (RAM) or any other dynamic storage device(s) commonly known in the art. Read-only memory 2460 can be any static storage device(s) such as programmable read-only memory (PROM) chips for storing static information such as instructions for processor 2420.

Mass storage device 2470 can be used to store information and instructions. For example, hard disks such as the Adaptec® family of SCSI drives, an optical disc, an array of disks such as RAID (e.g., the Adaptec family of RAID drives), or any other mass storage devices may be used.

Interconnect 2410 can be or include one or more buses, bridges, controllers, adapters, and/or point-to-point connections. Interconnect 2410 communicatively couples processor(s) 2420 with the other memory, storage, and communication blocks. Interconnect 2410 can be a PCI/PCI-X or SCSI-based system bus depending on the storage devices used.

Removable storage media 2450 can be any kind of external hard drives, floppy drives, compact disc read-only memory (CD-ROM), compact disc-rewritable (CD-RW), or digital versatile disc read-only memory (DVD-ROM).

The components described above are meant to exemplify some types of possibilities. In no way should the aforementioned examples limit the disclosure, as they are only exemplary embodiments.

### TERMINOLOGY

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the methods and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

In conclusion, the present disclosure provides novel systems, methods, and arrangements for trading physical commodities. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as they fall within the scope of the claims, together with all equivalents thereof. Therefore, the above description should not be taken as limiting.

What is claimed is:

1. A computerized method of performing multi-dimensional physical commodities trading, the method comprising:
receiving, from a computing device associated with a user:
a first order, wherein the first order is a purchase order relating to a physical commodity,
a second order, wherein the second order is a sell order relating to the physical commodity, and
a third order related to the physical commodity;
receiving instructions to execute the first order, the second order, and the third order simultaneously without user interaction when:
a first differential between the first order and the second order reaches a threshold, and
when a second parameter relating to the physical commodity reaches a second threshold;
continuously monitoring information relating to the physical commodity;
calculating, by the computing system, the first differential based on the information to determine whether the first differential has reached the threshold; and
executing the first order, the second order, and the third order when the first differential has reached the first threshold and when the second parameter reaches the second threshold to allow the user to profit from a spread or avoid losses.

2. The computerized method of claim 1, wherein the second parameter is a price of the physical commodity, a price of transportation for the physical commodity, or currency.

3. The computerized method of claim 1, wherein the first order is a contract to purchase the physical commodity, and wherein the second order is a contract to sell the physical commodity.

4. The computerized method of claim 3, wherein the first differential is a price between the contract to purchase the physical commodity and the contract to sell the physical commodity.

5. The computerized method of claim 1, further comprising: causing the first order, the second order, and the third order to be displayed on a computing device of the user.

6. The computerized method of claim 1, further comprising: prior to executing the order, determining matching orders for the first order, the second order, and the third order, wherein determining the matching orders comprises filtering orders from counterparties identified as blocked from trading with the user.

7. The computerized method of claim 1, wherein the first differential is a price differential between a first price of an aspect of the physical commodity and a second price of the aspect of the physical commodity.

8. The computerized method of claim 1, wherein the first differential is a contract delivery period differential between a first contract delivery period for the physical commodity and a second contract delivery period for the physical commodity.

9. A commodities trading platform, comprising:
one or more processors; and
a computer readable storage medium having instructions stored thereon, which when executed by the one or more processors cause the commodities trading platform to:
receive, from a computing device associated with a user:
a first order, wherein the first order is a purchase order relating to a physical commodity,
a second order, wherein the second order is a sell order relating to the physical commodity, and
a third order related to the physical commodity;
receive instructions to execute the first order, the second order, and the third order simultaneously without user interaction when:
a first differential between the first order and the second order reaches a threshold, and
when a second parameter relating to the physical commodity reaches a second threshold;
continuously monitor information relating to the physical commodity;
calculate the first differential based on the information to determine whether the first differential has reached the threshold; and
execute the first order, the second order, and the third order when the first differential has reached the first threshold and when the second parameter reaches the second threshold to allow the user to profit from a spread.

10. The commodities trading platform of claim 9, wherein the second parameter is a price of the physical commodity, a price of transportation for the physical commodity, or currency.

11. The commodities trading platform of claim 9, wherein the first order is a contract to purchase the physical commodity, and wherein the second order is a contract to sell the physical commodity.

12. The commodities trading platform of claim 11, wherein the first differential is a price between the contract to purchase the physical commodity and the contract to sell the physical commodity.

13. The commodities trading platform of claim 9, wherein the instructions, when executed by the one or more processors, further cause the commodities trading platform to: cause the first order, the second order, and the third order to be displayed on a computing device of the user.

14. The commodities trading platform of claim 9, wherein the instructions, when executed by the one or more processors, further cause the commodities trading platform to: prior to executing the order, determining matching orders for the first order, the second order, and the third order, wherein determining the matching orders comprises filtering orders from counterparties identified as blocked from trading with the user.

15. The commodities trading platform of claim 9, wherein the first differential is a price differential between a first price of an aspect of the physical commodity and a second price of the aspect of the physical commodity.

16. The commodities trading platform of claim 9, wherein the aspect is quality of the physical commodity.

17. The commodities trading platform of claim 9, wherein the first differential is a contract delivery period differential between a first contract delivery period for the physical commodity and a second contract delivery period for the physical commodity.

18. A computerized method of performing multi-dimensional physical commodities trading, the method comprising:
receiving, from a computing device associated with a user, at least two orders associated with the physical commodity and a threshold of a first differential between a first aspect relating to the physical commodity,
wherein the at least two orders are linked such that each order in the at least two orders executes simultaneously without user interaction when the each order in the at least two orders is matched;
continuously monitoring information relating to the physical commodity;
iteratively calculating, by the computing system, the first differential based on the information to determine whether the first differential has reached the threshold; and
when the first differential has reached the threshold and when the each order has been matched, executing the at least two orders simultaneously without user interaction.

19. The computerized method of claim 18, wherein the first aspect is a negotiable field of a market order, wherein the first aspect is one of: cost of transportation of the physical commodity, price of the physical commodity, contract period to buy or sell the physical commodity, or contract price to buy or sell the physical commodity.

20. The computerized method of claim 18, wherein the first aspect is a price of the physical commodity, wherein the first differential is a differential in the price of the physical commodity caused by a difference in currency prices.
